(19) United States
(12) Patent Application Publication
(10) Pub. No.: US 2017/0080638 A1
(43) Pub. Date: Mar. 23, 2017

(54) ELECTROFUSION SADDLE

(71) Applicant: PLASSON LTD., D.N. Menashe (IL)

(72) Inventor: Yoav LIVNE, Zichron Yaakov (IL)

(21) Appl. No.: 15/311,620

(22) PCT Filed: May 14, 2015
(86) PCT No.: PCT/IL2015/050519

§ 371 Date: Nov. 16, 2016

(30) Foreign Application Priority Data
May 19, 2014 (GB) 1408796.9

(51) Int. Cl. B29C 65/36; F16L 41/08; B29C 65/00

(52) U.S. Cl. CPC B29C 65/3624; B29C 66/131; B29C 66/73921; B29C 66/53243; F16L 41/084; B29K 2701/12

(57) ABSTRACT

An electrofusion saddle comprising: a thermoplastic body comprising a flange and optionally a spigot which erects from said flange; and a resistance heating coil including multiple windings, wherein said resistance heating coil is partially embedded in said flange and is partially protruding from said flange, wherein the protrusion is of at least 25% of an average external diameter of said multiple windings.

### FIELD OF THE INVENTION

The invention relates to the field of electrofusion saddles.

### BACKGROUND

Electrofusion is a well-established method of joining MDPE (medium-density polyethylene), HDPE (high-density polyethylene) and other plastic pipes using special fittings that have a built-in resistance heating coil used to weld the joint together.

The pipes to be joined are usually cleaned and scraped, inserted into an electrofusion fitting, and a voltage (typically 20-80 Volts) is applied to metal terminals of the fitting for a fixed time, commonly a few dozen seconds or minutes. The built-in resistance heating coil then melts the inside of the fitting and the outside of the pipe wall, which weld together and produce a strong joint. The assembly is then left to cool for a specified time, allowing the molten plastic to solidify.

One type of electrofusion fittings is the electrofusion saddle, used in cases where it is desired to branch an existing pipe. The saddle, sometimes called a “spigot saddle”, includes a spigot and an electrofusion surface. After the electrofusion surface of the saddle is welded to a main pipe, the spigot of the saddle forms a branch of the main pipe.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, an electrofusion assembly comprising: an electrofusion saddle comprising: (a) a thermoplastic body comprising a cylindrically-curved flange and a spigot which erects from said flange, and (b) a resistance heating coil including multiple windings around a common central axis, wherein said resistance heating coil is partially embedded in said flange and is partially protruding from said flange, wherein the protrusion is of at least 25% of an average external diameter of said multiple windings; and a harness configured to firmly secure said thermoplastic body to a target pipe, to enable the protrusion of said resistance heating coil to penetrate the target pipe during electrofusion.

There is further provided, in accordance with an embodiment, an electrofusion saddle comprising: a thermoplastic body comprising a flange and a spigot which erects from said flange; and a resistance heating coil including multiple windings around a common central axis, wherein said resistance heating coil is partially embedded in said flange and is partially protruding from said flange, wherein the protrusion is of at least 25% of an average external diameter of said multiple windings.

There is yet further provided, in accordance with an embodiment, a method for electrofusion, comprising: providing an electrofusion saddle comprising: (a) a thermoplastic body comprising a cylindrically-curved flange and a spigot which erects from said flange, and (b) a resistance heating coil including multiple windings around a common central axis, wherein said resistance heating coil is partially embedded in said flange and is partially protruding from said flange, wherein the protrusion is of at least 25% of an average external diameter of said multiple windings; positioning said electrofusion saddle about a target thermoplastic pipe which has not been scraped, such that said resistance heating coil is in contact with an outer surface of said target thermoplastic pipe; applying a voltage to said resistance heating coil, to melt portions of an outer layer of said flange and portions of an outer layer of said target thermoplastic pipe; during said applying of the voltage, applying force for attaching said flange to said target thermoplastic pipe, thereby causing the protrusion of said resistance heating coil to penetrate said outer layer of said target thermoplastic pipe; and allowing said outer layer of said flange and said outer layer of said target thermoplastic pipe to solidify, thereby forming a weld of said outer layer of said flange and said outer layer of said target thermoplastic pipe, with said resistance heating coil substantially embedded in said weld.

There is yet further provided, in accordance with an embodiment, an electrofusion assembly comprising: an electrofusion saddle comprising: (a) a thermoplastic body comprising a cylindrically-curved flange, and (b) a resistance heating coil including multiple windings around a common central axis, wherein said resistance heating coil is partially embedded in said flange and is partially protruding from said flange, wherein the protrusion is of at least 25% of an average external diameter of said multiple windings; and a harness configured to firmly secure said thermoplastic body to a target pipe, to enable the protrusion of said resistance heating coil to penetrate the target pipe during electrofusion.

There is yet further provided, in accordance with an embodiment, an electrofusion saddle comprising: a thermoplastic body comprising a flange; and a resistance heating coil including multiple windings around a common central axis, wherein said resistance heating coil is partially embedded in said flange and is partially protruding from said flange, wherein the protrusion is of at least 25% of an average external diameter of said multiple windings.

In some embodiments, said harness comprises a fastening cable and a fastening mechanism.

In some embodiments, said fastening cable encircles said flange and the target pipe.

In some embodiments, said thermoplastic body further comprises multiple niches through which said fastening cable is threaded.

In some embodiments, said flange comprises an opening at an intersection of said flange with said spigot.

In some embodiments, said resistance heating coil forms a spiral in said flange, said spiral encircling said opening.

In some embodiments, said thermoplastic body is made of medium-density polyethylene (MDPE).

In some embodiments, said thermoplastic body is made of high-density polyethylene (HDPE).

In some embodiments, said thermoplastic body is made of Polypropylene.

In some embodiments, said thermoplastic body is made of Polyamide.

In some embodiments, said flange comprises an opening at an intersection of said flange with said spigot.

In some embodiments, said flange has a cylindrical curvature, enabling attachment of the flange to a cylindrical target pipe.

In some embodiments, the electrofusion saddle further comprises a harness configured to firmly secure said thermoplastic body to a target pipe, to enable the protrusion of said resistance heating coil to penetrate the target pipe during electrofusion.

In some embodiments, said applying of force comprising force comprises tensioning a harness which encircles said electrofusion saddle and said target thermoplastic pipe.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a top isometric view of an exemplary electrofusion saddle;

FIG. 2 shows a bottom isometric view of the exemplary electrofusion saddle;

FIG. 3 shows a side view of the exemplary electrofusion saddle;

FIG. 4 shows a bottom view of the exemplary electrofusion saddle;

FIG. 5 shows a top view of the exemplary electrofusion saddle;

FIG. 6 shows a front isometric view of an exemplary electrofusion assembly;

FIG. 7 shows a back isometric view of the exemplary electrofusion assembly;

FIG. 8 shows a front view of the exemplary electrofusion assembly;

FIG. 9 shows a side view of the exemplary electrofusion assembly;

FIG. 10A shows a partial cross section of a saddle;

FIG. 10B shows another partial cross section of the saddle and the target pipe; and

FIG. 10C shows yet another partial cross section of the saddle and the target pipe, illustrating material distribution following electrofusion.

### DETAILED DESCRIPTION

An electrofusion saddle, an electrofusion assembly and a method for using the same are disclosed herein. Advantageously, the electrofusion saddle includes a protruding resistance heating coil, such that, when the electrofusion saddle is fused to a target pipe, the resistance heating coil substantially penetrates an outer layer of the target pipe.

The protruding resistance heating coil leads to one or more advantages: First, this penetration causes, after solidifying, a stitching effect of the electrofusion saddle to the target pipe, substantially enhancing the durability of the formed weld and its resistance to separation forces. Second, since the protruding resistance heating coil penetrates the target pipe, a substantial amount of the outer layer of the target pipe gets molten, mixing with a molten outer layer of the electrofusion saddle and further enhancing the durability of the formed weld, as well as its fluid sealing (i.e. leak tightness). Third, when the present electrofusion saddle is used, its sealing is at least partially insensitive to whether the target pipe is scraped prior to the electrofusion.

As to that third advantage, it is a common phenomenon that the outer layer of thermoplastic pipes becomes contaminated and/or oxidized over prolonged periods. The thickness of this contaminated and/or oxidized layer is commonly in the range of a few dozen microns up to a few hundred microns. Accordingly, it is a requirement in many standards, when using existing electrofusion saddles and fittings, to thoroughly scrape and remove this outer layer before attempting the electrofusion. Some standards suggest that a layer of about 200-300 microns be scraped. If this contaminated and/or oxidized outer layer is not removed, the forming weld may be weak and not sufficiently sealed, since this layer, when molten, may not form a quality weld with an outer layer of the electrofusion saddle. The scraping process is often said to be laborious, time-consuming, and requiring special tools. Hence, eliminating (or greatly mitigating) the need to scrape may significantly improve this industrially-common process of electrofusion.

Yet another advantage of the electrofusion assembly is the use of a harness which firmly secures the electrofusion saddle to the pipe at least during the electrofusion. The harness, which may include one or more wires, chains, bands, etc., may forcefully press together the electrofusion saddle and the pipe—particularly at the area where the resistance heating coil resides. Namely, the harness may be disposed over the area of the electrofusion saddle which includes the resistance heating coil—and that area may be pressed against the pipe. This stands in contrast to many existing electrofusion saddles, whose pressing against the pipe is rather indirect, for example via pulling peripheral areas of the saddle towards the pipe.

The terms “fusion” and “welding”, as referred to herein interchangeably, may relate to a melting of a portion of the thickness of two (or more) adjacent thermoplastic bodies using heat, and to a consequent common solidifying of the molten bodies, forming a weld between the two. The fusion/welding discussed herein may relate to electrofusion, in which the heat is generated by flowing electricity.

The term “thermoplastic”, as referred to herein with regard to the electrofusion saddle and the target pipe, may relate to a thermoplastic material such as MDPE (medium-density polyethylene), HDPE (high-density polyethylene), Polypropylene, Polyamide or other. This term may also relate to a mixture of such materials.

The term “target pipe”, as referred to herein, may relate to a pipe to which it is desired to electrofuse an electrofusion saddle, in order to form a branch of the target pipe.

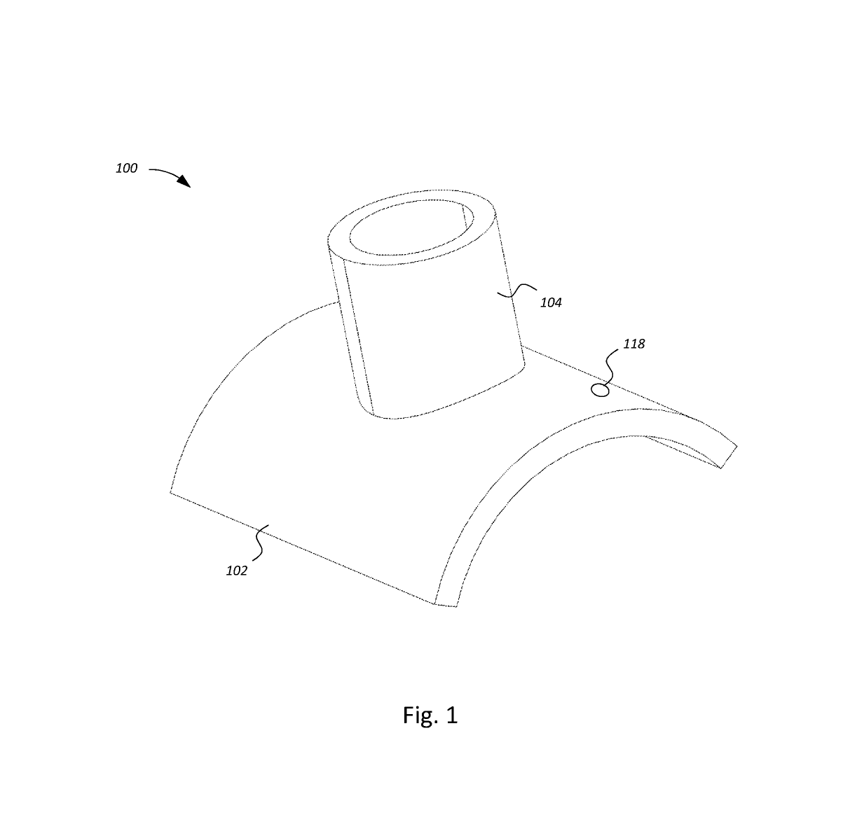

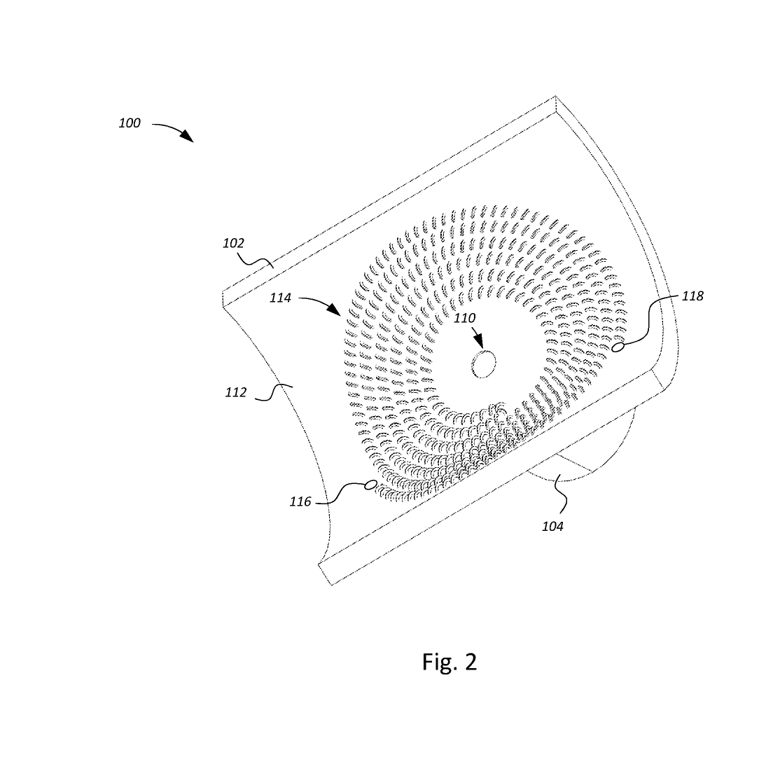

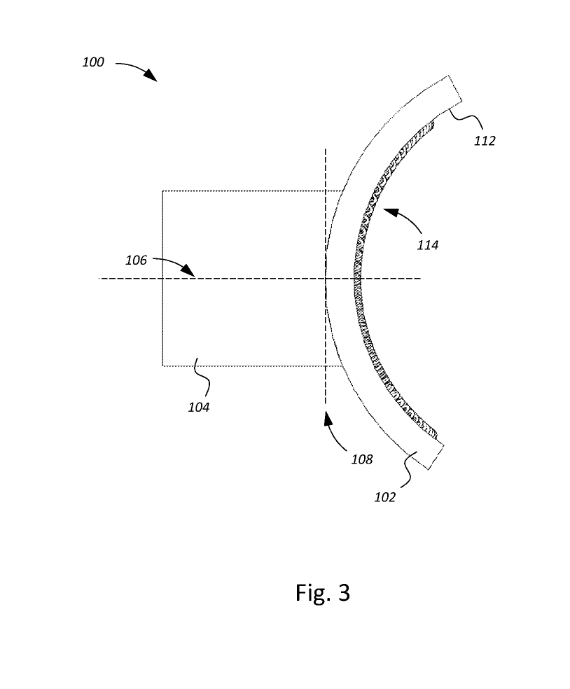

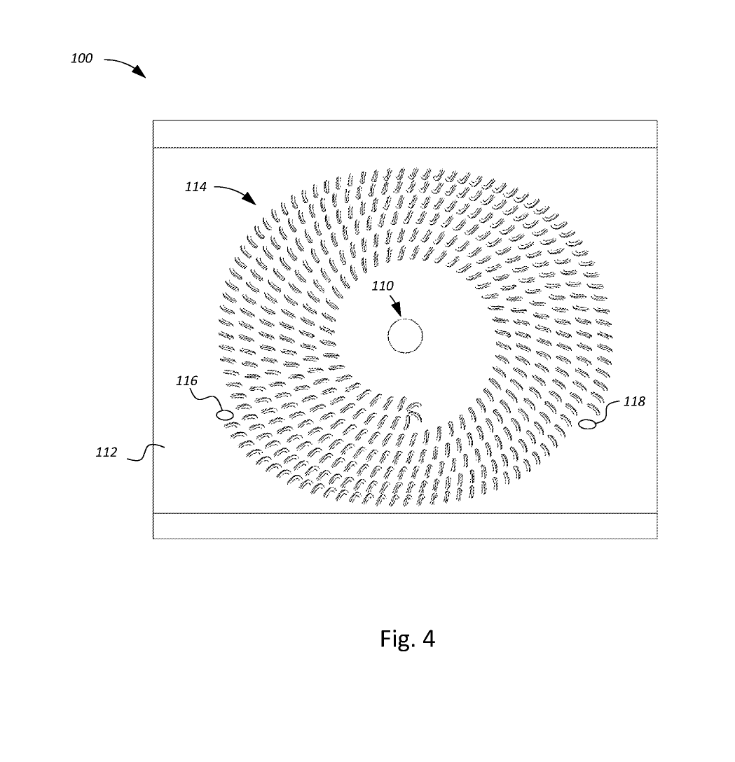

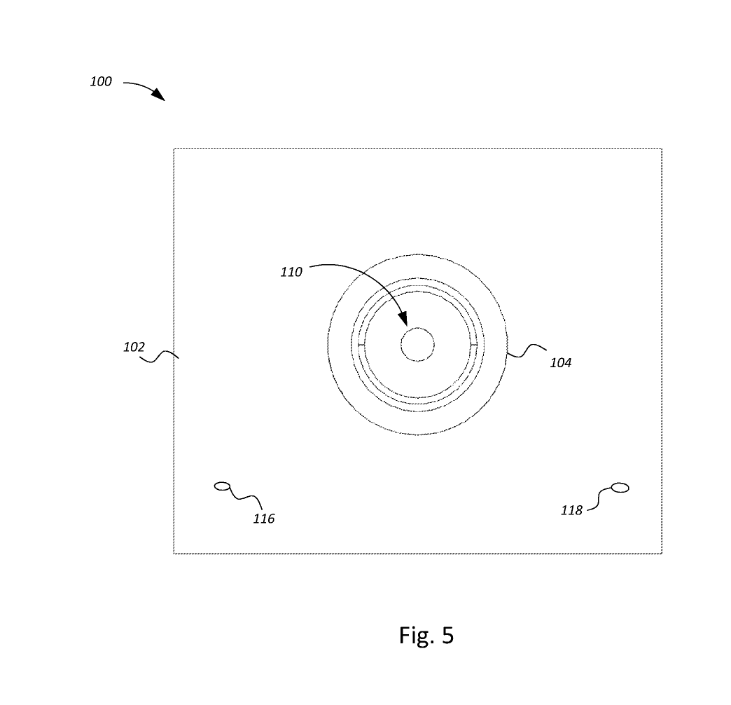

Reference is now made to FIGS. 1, 2, 3, 4 and 5, which show a top isometric view, a bottom isometric view, a side view, a bottom view and a top view, respectively, of an exemplary electrofusion saddle (hereinafter “saddle”) 100. Saddle 100 may include a thermoplastic body having a flange 102 and a spigot 104 which erects from the flange. Thermoplastic body may be integrally formed, for example using injection molding which forms flange 102 and spigot 104 together. Alternatively, flange 102 and spigot 104 may be attached to one another using welding, glue, and/or any other mechanical means.

In an alternative embodiment (not shown), a saddle may include only a flange, without any spigot. For this embodiment, the preceding and following discussions apply, naturally, only as to the flange. Such a saddle may be used, for example, to form a patch over a target pipe in order to seal a leak in the target pipe and/or in order to use the flange as a basis for mounting certain equipment on the target pipe.

Flange 102 may be shaped as a plate having a thickness of, for example, between 3 millimeters and 30 millimeters. A different thickness is also possible. The thickness of flange 102 may be uniform along its entire area; alternatively, its thickness may vary along its area. The thickness of flange 102 may be derived, for example, from the size of a target pipe, from anticipated fluid pressure in the target pipe, etc. Generally, a greater thickness may better cope with larger target pipes and greater pressures.

The plate constituting flange 102 may have, for example, a rectangular projection, circular projection, or any other projection. The term “projection” relates to the shape of the plate when spread out on a flat surface. Flange 102 is shown in the figure as having an approximately square projection.

The plate constituting flange 102 is shown cylindrically-curved, namely—at least its engagement surface 112 is shaped as a wall section of a symmetrical cylinder. The cylindrical curvature of flange 102 enables it to match an outer shape of a target pipe, to which the flange is to be attached using electrofusion. Although many target pipes are symmetrical cylinders, some target pipes may have a different outer shape, such as rectangular, triangular or asymmetric cylinder. Accordingly, in a different embodiment (not shown), a flange may have a different curvature or even be flat—to match an outer shape of a specific target pipe. Those of skill in the art will recognize how to apply the discussion of flange 102 to differently shaped and/or curved flanges.

Spigot 104 may be disposed such that its longitudinal axis 106 is perpendicular to a tangent 108 to flange 102, at a point of intersection between the longitudinal axis and the tangent. In an alternative embodiment (not shown), a pipe may be disposed at a different orientation relative to a flange (e.g. between 20°-90°). Moreover, it is hereby emphasized that spigot 104 is merely an example of a branch which a saddle may provide. Based on the same principles, a saddle may include any type of a fluid conduit which, after electrofusion, becomes in fluid communication with a target pipe and forms a branch of the target pipe. The fluid conduit may be, for example, a rigid or a flexible pipe, a connector (e.g. an internally- or externally-threaded connector) for connecting with another fluid conduit, a valve, etc. The fluid conduit may have any profile. The cylindrical profile of spigot 104 is merely one example. In addition, a single saddle may include multiple fluid conduits for forming multiple branches of the target pipe. The multiple fluid conduits may each be separately in fluid communication with the target pipe (i.e. parallel connection) or be connected in series to one another.

Flange 102 may include an opening 110 at an intersection of the flange and spigot 104, which opening extends from an engagement surface 112 of the flange to an inner void of the pipe. Namely, when saddle 100 is electrofused to the target pipe and an opening is formed in the target pipe opposite to opening 110, fluid communication is formed between the target pipe and spigot 104. In an alternative embodiment (not shown), a flange may be manufactured without such an opening; instead, a suitable opening may be drilled or otherwise formed in the field, after the saddle has been electrofused to the pipe. This drilling may include forming an opening in the flange and a respective opening in the pipe in the same drilling operation. In an alternative scenario, when the electrofusion of a saddle to a target pipe is not for purposes of branching the pipe, then an opening may not be drilled or formed at all—neither in the flange nor in the target pipe.

Opening 110 is shown as being circular and having a diameter smaller than an internal diameter of spigot 104. However, in other embodiments (not shown), an opening may have a different shape, size and/or location in a flange—as long as such opening enables fluid communication between a pipe of a saddle and a target pipe. The decision of the size of the opening, for example, may be influenced by a desire to control fluid flow and pressure through the opening. It is also possible to include multiple openings in a single saddle, whether these lead to a single pipe of a saddle or to multiple pipes of a saddle.

Flange 102 further includes a resistance heating coil (hereinafter “coil”) 114. As known in the art, when electric current flows through coil 114, it encounters resistance which results in the coil being heated. Coil 114 may be made of metal. Suitable metals include, for example, alloys such as Nichrome, Kanthal and Cupronickel, or Copper. In another embodiment (not shown), a different heating element may be used in lieu of coil 114. For example, a ceramic heating element or a composite heating element may be used, which may also be shaped differently from coil 114 (e.g. shaped as an elongated stripe).

Coil 114 may be a metal wire which is spirally wound around a common central axis. Windings along the length of coil 114 may have a uniform or a varying external diameter. The term “external diameter” may relate to an inner diameter of the windings, with the addition of twice the diameter of the wire itself. The diameter of the wire may be, for example, between 100 microns and 4 millimeters.

Advantageously, coil 114 may be partially embedded in flange 102 and partially protruding from the flange, namely—from its engagement surface 112. In other words, each of the windings (or at least a majority thereof) is partially sunk inside the thermoplastic material of flange 114, and partially protrudes from it. Optionally, up to three quarters (75%) of the average external diameter of the windings is embedded in flange 102, which leaves at least one quarter (25%) of the average external diameter of the windings protruding from the flange. Exemplary distributions of embedded vs. protruding average external diameter of the windings are listed in Table 1 below:

TABLE 1
Exemplary distributions of embedded vs. protruding

| | Embedded | Protruding |
|---|---|---|
| Exemplary distribution 1 | 75% | 25% |
| Exemplary distribution 2 | 70% | 30% |
| Exemplary distribution 3 | 65% | 35% |
| Exemplary distribution 4 | 60% | 40% |
| Exemplary distribution 5 | 55% | 45% |
| Exemplary distribution 6 | 50% | 50% |
| Exemplary distribution 7 | 45% | 55% |
| Exemplary distribution 8 | 40% | 60% |
| Exemplary distribution 9 | 35% | 65% |
| Exemplary distribution 10 | 30% | 70% |
| Exemplary distribution 11 | 25% | 75% |

For simplicity of illustration, values in Table 1 are shown in increments of 5%. However, it is intended that any intermediate value is also possible, in some embodiments.

The winding of coil 114 may be such that the average external diameter of the windings measures, for example, between 2 and 30 millimeters.

The amount of protrusion of coil 114 from flange 102 may be set such that, during electrofusion, the coil is able to penetrate the target pipe at least to a thickness of the contaminated and/or oxidized outer layer of the target pipe, and optionally also beyond that thickness. Merely as an illustrative example, if it is desired to electrofuse a saddle to a target pipe whose contaminated and/or oxidized outer layer is 200 microns thick, then a saddle with a coil capable of penetrating at least 200 microns deep into the target pipe may be used. Accordingly, in some embodiments, the coil protrusion is of at least 50% of the thickness of the contaminated and/or oxidized outer layer of the target pipe. In some other embodiments, the coil protrusion is of at least 75% of the thickness of the contaminated and/or oxidized outer layer of the target pipe. In some further embodiments, the coil protrusion is of at least 100% of the thickness of the contaminated and/or oxidized outer layer of the target pipe. In yet other embodiments, the coil protrusion is of at least 125% of the thickness of the contaminated and/or oxidized outer layer of the target pipe.

The term “thickness of the contaminated and/or oxidized outer layer of the target pipe”, as referred to herein, may relate to an estimated thickness. The estimation may be based, for example, on one or more characteristics of the thermoplastic material of the target pipe (e.g. the type of material, its porosity, its density, etc.), on one or more environmental parameters (e.g. weather to which the target pipe has been exposed), and/or on the amount of time the target pipe has been exposed to these environmental parameters. The effect of these factors on the estimated thickness may be experimentally determined by a manufacturer of the saddle. Additionally or alternatively, the user who wishes to install a saddle in the field, may first scratch the target pipe over a relatively small area, and visually estimate how much of the outer layer of the target pipe is contaminated and/or oxidized. Then, the user may choose a saddle with a suitable coil protrusion.

During electrofusion, the protrusion of coil 114 from flange 102 may, naturally, evacuate molten material from within the target pipe, to make room for the penetrating portions of the coil. Namely, if the protrusion reaches deep enough in the target pipe, it is capable, when heated, to melt non-contaminated and/or non-oxidized material deep within the target pipe, and evacuate it towards the interface between engagement surface 112 and the outer surface of the target pipe. This material, together with the molten material of flange 102, may form a quality weld between saddle 100 and the target pipe.

The partial embedding of coil 114 may be such that the coil forms a spiral encircling opening 110. This spiral should not be confused with the spiral winding of coil 114 itself, which may be referred to as a “primary” spiral of the coil. The spiral formed by coil 114 around opening 110 is, essentially, a secondary spiral of the coil. The spiral formed by coil 114 around opening 110 may have between 2 and 20 windings around the opening. These windings may begin, for example, at a distance of at least 1 centimeter from opening 110 or, if there is no such opening, from a center of flange 102 where an opening is to be later drilled. The purpose for this spacing is that edges of the opening do not melt when coil 114 heats up. In an alternative embodiment (not shown), where no opening is present in the flange, a secondary spiral may be disposed also in a position where an opening is to be drilled later; that is, the drilling will also drill into the coil.

The distance between every two adjacent windings may be, for example, between 1 millimeter and 1 centimeter. Other values are also intended herein.

Coil 114 may terminate, at its opposing ends, with two conductive (e.g. metal) terminals, a first terminal 116 and a second terminal 118. As shown in the figure, first terminal 116 and second terminal 118 are disposed externally to the spiral which coil 114 forms. In other embodiments (not shown), however, terminals may be located differently, as long the coil extending therebetween surrounds the opening in the flange. First terminal 116 and second terminal 118 may either be conductive bodies being in galvanic contact to coil 114, or simply be the two opposing ends of the coil itself.

It is also possible to have the coil disposed with a geometry different than a spiral, as long as it overall surrounds the opening. Generally, any disposition of a coil around an opening may be suitable, if, during electrofusion, molten material will fully encircle the hole, to provide sealing.

First terminal 116 and second terminal 118 may pass through the body of flange 102, such that, when saddle 100 is positioned about a target pipe, the terminals are accessible to a user from outside the saddle, for connecting them to power. In an alternative embodiment (not shown), voltage may be applied to a coil through induction, rather than by galvanic contact with terminals. Namely, this alternative embodiment may lack terminals, and instead include an inductive power transfer mechanism, as known in the art.

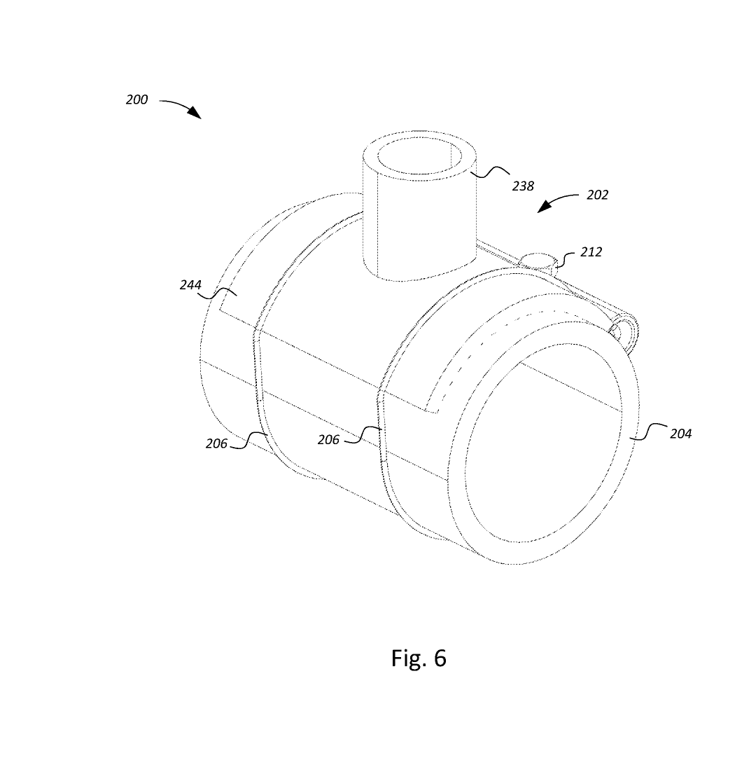

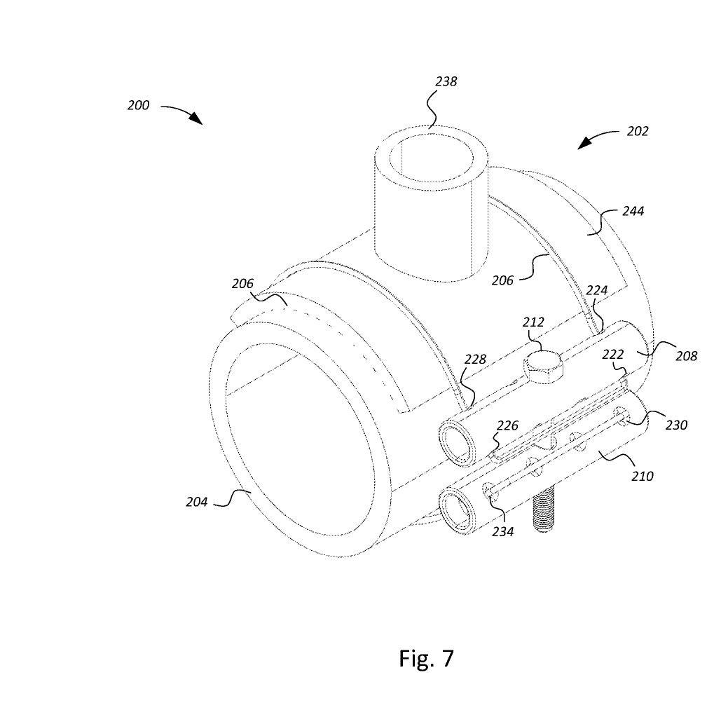

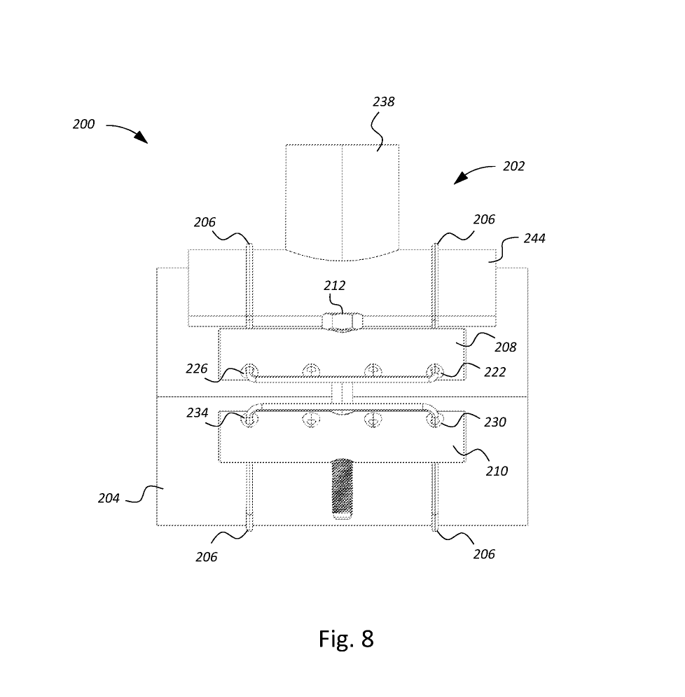

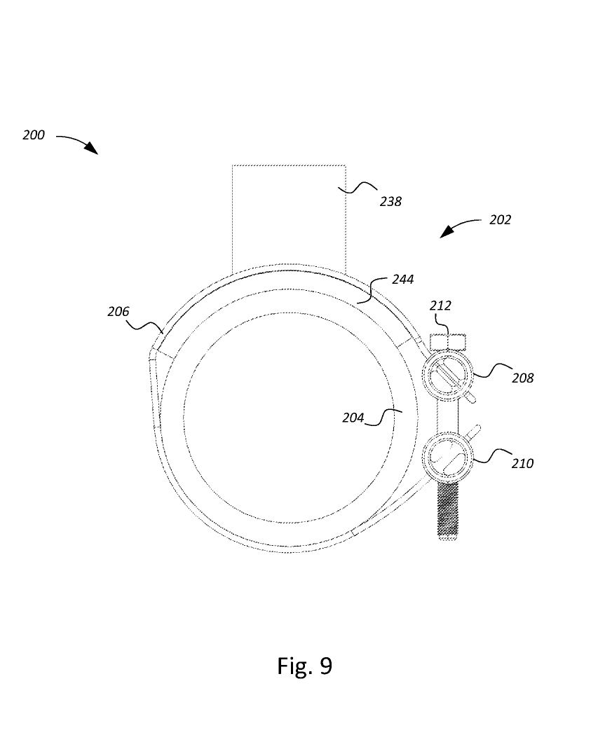

Reference is now made to FIGS. 6, 7, 8 and 9, which show a front isometric view, a back isometric view, a front view and a side view, respectively, of an exemplary electrofusion assembly (hereinafter “assembly”) 200. Assembly 200 includes, in addition to a saddle 202, an advantageous harness configured to firmly secure the saddle to a target pipe 204. Saddle 202 may be similar or identical to saddle 100 of FIGS. 1-5, except where explicitly indicated below. Corresponding elements of saddle 202 and saddle 100 are named the same, even if they are not explicitly referenced or shown in FIGS. 6, 7, 8 and 9.

The harness may include one or more wires, chains, bands and/or any other suitable elongated members capable of encircling saddle 202 and target pipe 204 fully or partially. Merely as an example, FIGS. 6, 7, 8 and 9 show the harness as including a cable 206 which encircles both saddle and target pipe 204. A fastening mechanism may be used in order to conveniently and forcefully fasten (i.e. tension) cable 206 over saddle 202 and target pipe 204. In this example, the fastening mechanism includes a pair of rigid structures such as tubes, a top tube 208 and a bottom tube 210, as well as one or more screws, such as a screw 212 securing the two tubes together, for example by threading through internal threads (not shown) in one or more of the tubes.

Tubes 208 and 210 may be made of metal, plastic, and/or any rigid and durable material or combination of materials. Tubes 208 and 210 are shown hollow, but may alternatively be solid. Each of tubes 208 and 210 may include at least two cable passages through which cable 206 may be threaded. Each such passage may include two opposing holes in the wall of the tube; for example, top tube 208 may include two passages, one with two opposing holes 222 and 224, and the other with two opposing holes 226 and 228. Bottom tube 210 may include two passages, one with two opposing holes 230 and the second not shown, and the other with two opposing holes 234 and the second not shown. Further passages may be provided in order to be able to alter the path of cable 206.

During manufacturing of assembly 200, cable 206 may be first threaded through the two passages of each of tubes 208 and 210. Then, two opposing ends (not shown) of cable 206 may be connected or attached to one another, to form cable 206 as a closed loop.

Optionally, saddle 202 may include multiple niches (not shown) in a top surface of flange 244 (the surface opposite engagement surface 242), through which cable 206 may be threaded. That is, the niches may force cable 206 to pass over flange 244 in a certain path, and ensure that the cable does not slip away from the flange upon its tensioning.

In the field, when a user desires to electrofuse saddle 202 to target pipe 204, the user may first position the saddle over the pipe at a desired area thereof. Screw 212, at this point, may only be threaded through top tube 208. The user may then position the harness over saddle 202 and target pipe 204, namely—encircle the saddle and the target pipe with cable 206. When positioning the harness, a first portion of cable 206 may encircle saddle 202 and target pipe 204 on one side of a spigot 238, and a second portion of the cable may encircle the saddle and the target pipe on the other side of the spigot. Optionally, cable 206 passes at a distance of up to 4 centimeters from spigot 238, but greater distances are possible as well, such as up to 10 centimeters or 20 centimeters. Generally, the passage of cable 206 over flange 244 may be designed such that the cable passes over the area where the coil is disposed, thereby directly applying force to this area.

Then, the user may thread screw 212 into a threaded hole 240 in bottom tube 210, to gradually increase the tension of cable 206, thereby firmly securing saddle 202 to target pipe 204.

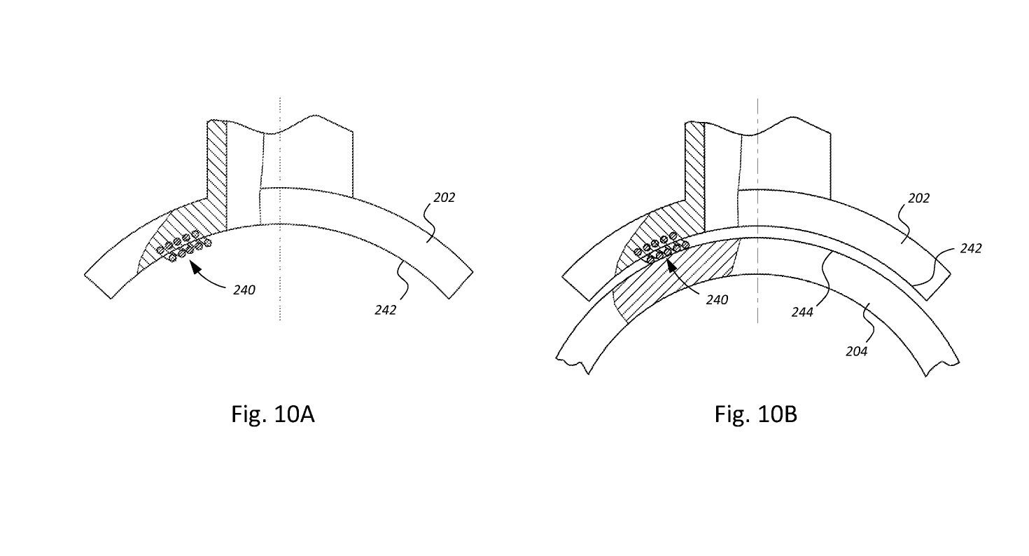

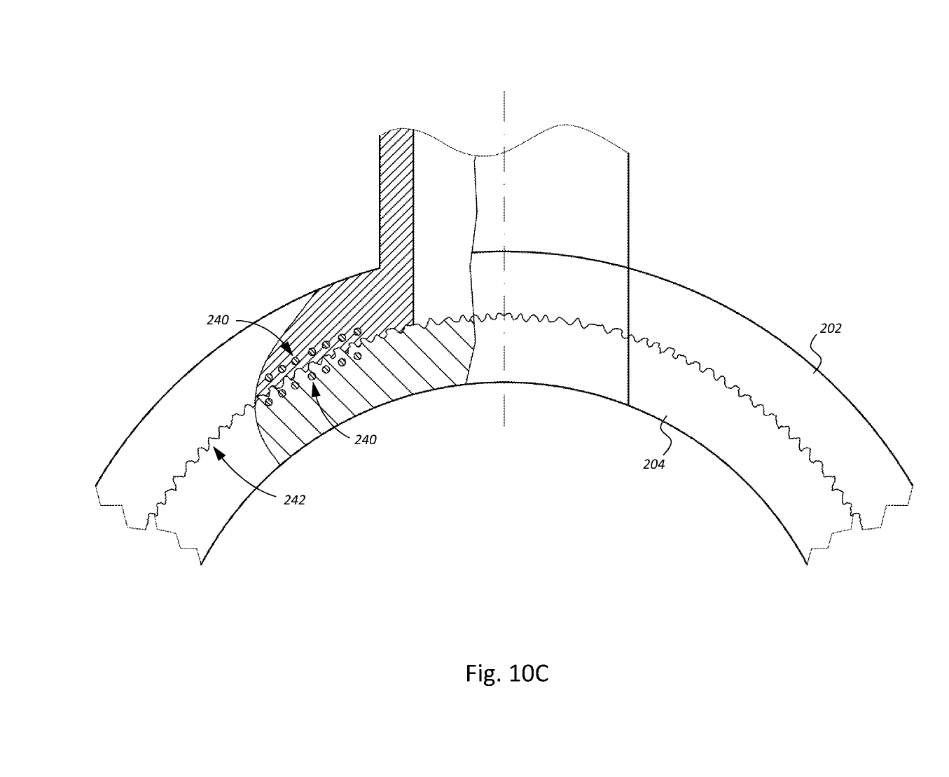

Reference is now made to FIGS. 10A, 10B and 10C, which show a partial cross section of saddle 202 and target pipe 204 in three stages of a method for mounting the saddle to the target pipe (also “a method for electrofusion”). FIG. 10A shows saddle 202 with its coil 240 partially protruding from an engagement surface 242 of the saddle. For simplicity of illustration, only a portion of coil 240 is shown.

FIG. 10B shows saddle 202 when it is positioned about target pipe 204; coil 240 contacts an outer surface 244 of the target pipe. The harness, although not shown in this figure for reasons of simplicity, may already be present and optionally tensioned over saddle 202 and target pipe 204, to firmly secure the saddle to the target pipe. Since coil 240 contacts target pipe 204 and prevents engagement surface 242 of saddle 202 from fully contacting the target pipe, the tension of the harness may cause a flange 244 of the saddle to bend towards the target pipe. The degree of bending is dependent on the material of saddle 202, the thickness of flange 244 and the amount of harness tension.

After saddle 202 is positioned about and secured to target pipe 204, voltage may be applied to the two terminals (not shown here) of the saddle. The voltage commonly used in similar electrofusion methods is approximately 20-80 Volts, however a different voltage, or a voltage that varies with time, is also intended herein. As an alternative, voltage may be applied using conductive power transfer, without galvanic contact between the power source and the coil.

The application of the voltage may be for a predetermined period of time, commonly seconds or minutes, but sometimes even an hour or more. This predetermined period of time may be decided by a manufacturer of saddle 202 based on one or more parameters such as the material of saddle 202, the thickness of flange 244, the size of saddle 202, the material of target pipe 204, the wall thickness of target pipe 204, the diameter of target pipe 204, the diameter of the wire forming coil 240, the external diameter of coil 240, the amount of harness tension and/or the like. The manufacturer may provide, with saddle 202, a suitable user manual which specifies one or more of the voltage and period of time.

The voltage heats coil 240 to a temperature above the melting point of the thermoplastic material of the saddle and the target pipe, which causes both an outer layer of flange 244 and an outer layer of target pipe 204 to melt. The thermoplastic material which melts is, essentially, that material which is located at a certain effective distance from the wire of coil 240. The effective distance, which may be influenced by one or more of the diameter of the wire forming coil 240, the characteristics of thermoplastic material(s), the energy applied—may be in the range of 100 microns to 15 millimeters, for example. In other embodiments, the effective distance is lower or higher than this exemplary range. The molten thermoplastic material of the outer layer of flange 244 and the outer layer of target pipe 204 may mix.

FIG. 10C shows saddle 202 and target pipe 204 after the heating of coil 240 caused its protruding part to melt the target pipe and penetrate it, and after the molten material has solidified. The melting had made it harder to distinguish between the engagement surface of saddle 202 and the outer surface of target pipe 204. Hence, the borderline between these surfaces is now shown as a fuzzy line 242, with coil 240 having a presence both within saddle 202 and within target pipe 204. It should be noted, however, that FIG. 10C is meant for illustrative reasons only, to demonstrate the stitching effect achieved, by virtue of coil 240, between saddle 202 and target pipe 204. In practice, the molten material from both saddle 202 and target pipe 204 may at least partially intermix, such that there may be no clear borderline between the two.

The method for mounting a saddle to a target pipe, in accordance with some embodiments, may be summarized as follows: First, an electrofusion saddle or an electrofusion assembly which includes a saddle may be provided. Second, the saddle may be positioned about a target pipe, such that the coil of the saddle is in contact with an outer surface of the target pipe. Third, force may be applied to press the saddle and the target pipe together, for attaching the flange of the saddle to the target pipe. This force is optionally applied by harness. Then, voltage may be applied to the coil, to melt portions of an outer layer of the flange and portions of the outer layer of the target thermoplastic pipe. The voltage may be applied while the force for attaching the flange of the saddle to the target pipe is applied. Finally, the application of the voltage may be ceased and the outer layer of the flange and the outer layer of the target pipe may be left to solidify, thereby forming a weld of said outer layer of said flange and said outer layer of said target thermoplastic pipe, with said resistance heating coil substantially embedded in said weld.

After the weld solidifies, one or more holes may be formed in the target pipe opposite the opening in the flange, so that the target pipe becomes in fluid communication with the pipe of the saddle. Alternatively, the one or more holes may be formed prior to electrofusion, after the saddle has been positioned about the target pipe.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

1-11. (canceled)

12. The electrofusion saddle according to claim 33, wherein said thermoplastic body further comprises a spigot which erects from said flange, and wherein flange comprises an opening at an intersection of said flange with said spigot.

13. The electrofusion saddle according to claim 12, wherein said resistance heating coil forms a spiral in said flange, said spiral encircling said opening.

14. The electrofusion saddle according to claim 33, wherein said flange has a cylindrical curvature, enabling attachment of the flange to a cylindrical target pipe.

15. The electrofusion saddle according to claim 33, further comprising a harness configured to firmly secure said thermoplastic body to a target pipe, to enable the protrusion of said resistance heating coil to penetrate the target pipe during electrofusion.

16. The electrofusion saddle according to claim 15, wherein said harness comprises a fastening cable and a fastening mechanism.

17. The electrofusion saddle according to claim 16, wherein said fastening cable encircles said flange and the target pipe.

18. The electrofusion saddle according to claim 17, wherein said thermoplastic body further comprises multiple niches through which said fastening cable is threaded.

19. The electrofusion saddle according to claim 33, wherein said thermoplastic body is made of medium-density polyethylene (MDPE).

20. The electrofusion saddle according to claim 33, wherein said thermoplastic body is made of high-density polyethylene (HDPE).

21. The electrofusion saddle according to claim 33, wherein said thermoplastic body is made of Polypropylene.

22. The electrofusion saddle according to claim 33, wherein said thermoplastic body is made of Polyamide.

23. A method for electrofusion, comprising:
providing an electrofusion saddle comprising: (a) a thermoplastic body comprising a cylindrically-curved flange and a spigot which erects from said flange, and (b) a resistance heating coil including multiple windings around a common central axis and along the length of the resistance heating coil, wherein said resistance heating coil is partially embedded in said flange and is partially protruding from said flange, wherein the protrusion is of at least 25% of an average external diameter of said multiple windings;
positioning said electrofusion saddle about a target thermoplastic pipe which has not been scraped, such that said resistance heating coil is in contact with an outer surface of said target thermoplastic pipe;
applying a voltage to said resistance heating coil, to melt portions of an outer layer of said flange and portions of an outer layer of said target thermoplastic pipe;
during said applying of the voltage, applying force for attaching said flange to said target thermoplastic pipe, thereby causing the protrusion of said resistance heating coil to penetrate said outer layer of said target thermoplastic pipe; and
allowing said outer layer of said flange and said outer layer of said target thermoplastic pipe to solidify, thereby forming a weld of said outer layer of said flange and said outer layer of said target thermoplastic pipe, with said resistance heating coil substantially embedded in said weld.

24. The method according to claim 23, wherein said flange comprises an opening at an intersection of said flange with said spigot.

25. The method according to claim 24, wherein said resistance heating coil forms a spiral in said flange, said spiral encircling said opening.

26. The method according to claim 23, wherein said flange has a cylindrical curvature, and said target thermoplastic pipe is cylindrical.

27. The method according to claim 23, wherein said applying of force comprises tensioning a harness which encircles said electrofusion saddle and said target thermoplastic pipe.

28. The method according to claim 23, wherein said thermoplastic body is made of a material selected from the group consisting of: medium-density polyethylene (MDPE), high-density polyethylene (HDPE), Polypropylene, and Polyamide.

29-32. (canceled)

33. An electrofusion saddle comprising:
a thermoplastic body comprising a flange; and
a resistance heating coil including multiple windings around a common central axis and along the length of the resistance heating coil, wherein said resistance heating coil, when non-electrified, is partially embedded in said flange and is partially protruding from said flange, wherein the protrusion is of at least 25% of an average external diameter of said multiple windings.

34-36. (canceled)
